(19) United States
(12) Patent Application Publication
(10) Pub. No.: US 2001/0007992 A1
(43) Pub. Date: Jul. 12, 2001

(54) Transfer method, transfer system and transfer apparatus for E-mail

(76) Inventor: Yasuo Nakaoka, Kanagawa (JP)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/734,187

(22) Filed: Dec. 12, 2000

(30) Foreign Application Priority Data
Dec. 13, 1999 (JP) 11-353666
Dec. 6, 2000 (JP) 2000-371658

(51) Int. Cl. G06F 15/16

(52) U.S. Cl. 709/206

(57) ABSTRACT

To provide an arrangement wherein an E-mail can be processed efficiently according to the contents of the body, and an E-mail can be transferred to a mobile phone without inconvenience. Confirmation is made whether or not a row of characters to be an object as the transfer conditions preset is contained in the contents of the body of an E-mail received, and if contained, determination is made that the transfer conditions are met, and the E-mail is transferred to a transfer address preset. Further, after the E-mail has been transferred, the E-mail may be remained, and when the E-mail is transferred, an attached file is deleted, the space or new lines are deleted, or the number of transferable characters is limited.

### BACKGROUND OF THE INVENTION

1. Field of the Invention

The present invention relates to a transfer method, a transfer system and a transfer apparatus for transferring E-mail (Electronic mail) to a fixed client apparatus.

2. Related Art Statement

With the widespread of personal computers and Internet, it has become active that information be transmitted by E-mail. The E-mail is very convenient because a transmitter and a receiver may transmit and receive E-mail at a suitable place at suitable time without giving heed to the convenience of the other party and irrespective of company, destination, home and the like.

Even such convenient E-mail, where E-mail is not read out from a mail server device due to the absence of a receiver or the like, variable E-mail is merely present in a mail box within the mail server's device and does not arrive at the client's device so that information cannot be transmitted to the receiver at suitable time.

So, the transfer method and the apparatus have been proposed, as disclosed in Japanese Patent Application Laid-Open Nos. Hei 3 (1991)-268540, Hei 11 (1999)-4251 and the like, in which where E-mail is not read out from a mail server's device due to the absence of a receiver, E-mail received is transferred to a client's device of a substitute. According to the aforementioned Japanese Patent Application Laid-Open Nos. Hei 3 (1991)-268540, and Hei 11 (1999)-4251, E-mail is transferred to the substitute appointed suitably corresponding to the attribute of E-mail.

However, in these conventional transfer methods and apparatuses, E-mail is not transferred to a transfer address suitably appointed when the described matter of the body of E-mail coincides with the set conditions. Accordingly, E-mail received being addressed to a client's device of a company cannot be transferred to the client device at the destination with the described content of the body, and cannot be transferred to the client device at home; therefore E-mail received could not be processed efficiently.

Recently, E-mail can be transmitted or received even by a mobile telephone. In the telephone, the number of characters capable of being displayed is limited, and an attached file cannot be received. Accordingly, E-mail received addressed to a client's device of a company cannot be transferred to the mobile telephone as it is, and urgent information or necessary information described in the body of E-mail received could not be transmitted to business staff outside, for example, promptly.

### SUMMARY OF THE INVENTION

The present invention has been accomplished in view of a problem as noted above with respect to prior art. An object of the present invention is to provide an arrangement wherein when the described matter of the body of E-mail coincides with the set conditions, E-mail is transferred to a transfer address appointed suitably so that E-mail can be processed efficiently according to the described contents of the body; and E-mail can be transferred to a mobile telephone without inconvenience so that urgent information or necessary information described in the body of E-mail received can be transmitted to business staff outside or the like promptly.

Achieving the aforementioned object, a transfer method for E-mail according to the present invention is characterized in that confirmation is made whether or not a row of characters to be an object as the transfer conditions preset is contained in the contents of the body of E-mail received, and if contained, determination is made that the transfer conditions are met, and E-mail is transferred to a transfer address preset.

Here, after E-mail has been transferred, the E-mail may be remained, or when E-mail is transferred, an attached file may be deleted, or the number of transferable characters may be limited.

Further, a transfer system for E-mail according to the present invention comprises a transfer apparatus for E-mail comprising a transfer condition setting section capable of setting, as the transfer conditions, a row of characters to be an object supposed to be contained in the contents of the body of E-mail received and a transfer address, a transfer condition memory section for storing, as the transfer conditions, the row of characters to be an object supposed to be contained in the contents of the body of E-mail received and the transfer address, a newly-received mail confirmation section for confirming whether or not a newly-received mail is present within a mail memory section of a mail server device, a collation and determination section for collating the body of E-mail received with the row of characters to be an object stored in the transfer condition memory section to determine whether or not the row of characters to be an object is contained in the contents of the body of the E-mail, and a mail transfer command section for issuing a command to a mail transmission section of the mail server device, so as to transfer the E-mail to the transfer address stored in the transfer condition memory section; and a client device capable of getting access to the E-mail transfer device to input the row of characters to be an object and the transfer address as the transfer conditions.

Furthermore, a transfer apparatus for E-mail according to the present invention comprises a transfer condition setting section capable of setting, as the transfer conditions, a row of characters to be an object supposed to be contained in the contents of the body of E-mail received and a transfer address, a transfer condition memory section for storing, as the transfer conditions, the row of characters to be an object supposed to be contained in the contents of the body of E-mail received and the transfer address, a newly-received mail confirmation section for confirming whether or not a newly-received mail is present within a mail memory section of a mail server device, a collation and determination section for collating the body of E-mail received with the row of characters to be an object stored in the transfer condition memory section to determine whether or not the row of characters to be an object is contained in the contents of the body of the E-mail, and a mail transfer command section for issuing a command to a mail transmission section of the mail server device, so as to transfer the E-mail to the transfer address stored in the transfer condition memory section.

### BRIEF DESCRIPTION OF THE DRAWINGS

FIG. 1 is a conceptual view showing a transfer method for E-mail according to the present invention.

FIG. 2 is a constitutional view of a transfer system for E-mail according to the present invention.

FIG. 3 is a flow chart showing a user registration and confirmation processing.

FIG. 4 shows a “Log on” screen.

FIG. 5 shows a “Log on” screen.

FIG. 6 is a flow chart showing a process for setting a mail receiver and the like.

FIG. 7 shows an “Option” screen.

FIG. 8 is a flow chart showing a process for setting a mail transfer address and the like.

FIG. 9 shows a “List of Transfer Addresses” screen.

FIG. 10 shows an “Edit Transfer Addresses” screen.

FIG. 11 is a flow chart showing a process for setting the mail transfer conditions and the like.

FIG. 12 is a flow chart showing a process for setting the mail transfer conditions and the like.

FIG. 13 shows a “List of Rules” screen.

FIG. 14 shows an “Edit Rules” screen.

FIG. 15 is a flow chart showing an E-mail transfer method.

FIG. 16 is a flow chart showing an E-mail transfer method.

FIG. 17 shows a format of an E-mail to start or to stop the transfer.

FIG. 18 shows an “Edit Rules” screen.

FIG. 19 shows a Deleting Function of Consecutive Characters.

FIG. 20 shows an “Edit Transfer Addresses” screen.

### DETAILED DESCRIPTION OF THE INVENTION

Referring now to the drawings, the transfer method, the transfer system, and the transfer apparatus for E-mail according to the present invention will be described in detail.

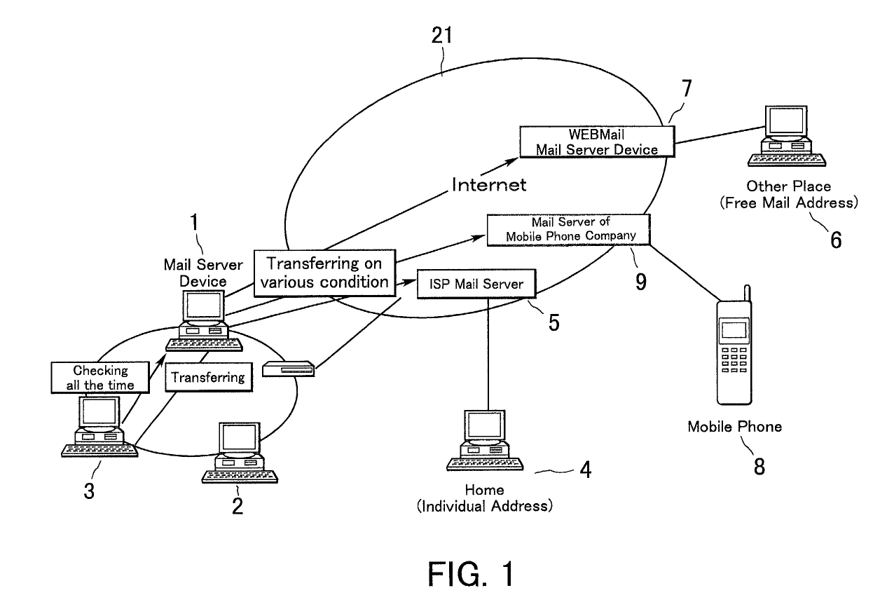

FIG. 1 is a conceptual view showing a transfer method for E-mail according to the present invention. In the transfer method for E-mail according to the present invention, E-mail addressed to a client device 2 received by a mail server device 1 is transferred, in accordance with the transfer conditions set in an E-mail transfer apparatus 3, to a mail server device 5 of a client device 4 such as a personal computer or the like installed at home, to a mail server device 7 of a client device 6 such as a personal computer placed at other place, and a mail server device 9 of a client device 8 such as a mobile telephone.

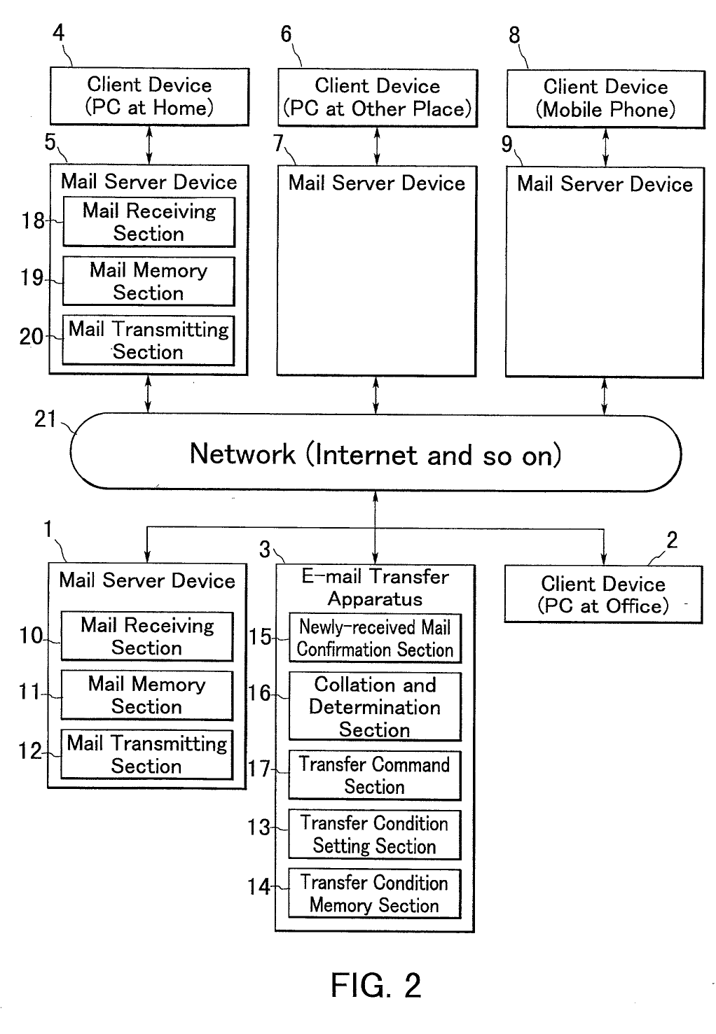

FIG. 2 is a constitutional view of a transfer system for E-mail according to the present invention. The mail server device 1 includes a mail receiving section 10, a mail memory section 11, and a mail transmitting section 12. The E-mail transfer device 3 includes a transfer condition setting section 13, a transfer condition memory section 14, a newly-received mail confirmation section 15, a collation and determination section 16, and a mail transfer command section 17. The mail server devices 5, 7 and 9 include a mail receiving section 18, a mail memory section 19, and a mail transmitting section 20. The mail server device 1 and the mail server devices 5, 7 and 9 are connected through a network 21 such as Internet.

First, the setting of the E-mail transfer system will be described with reference to flow charts and display screens.

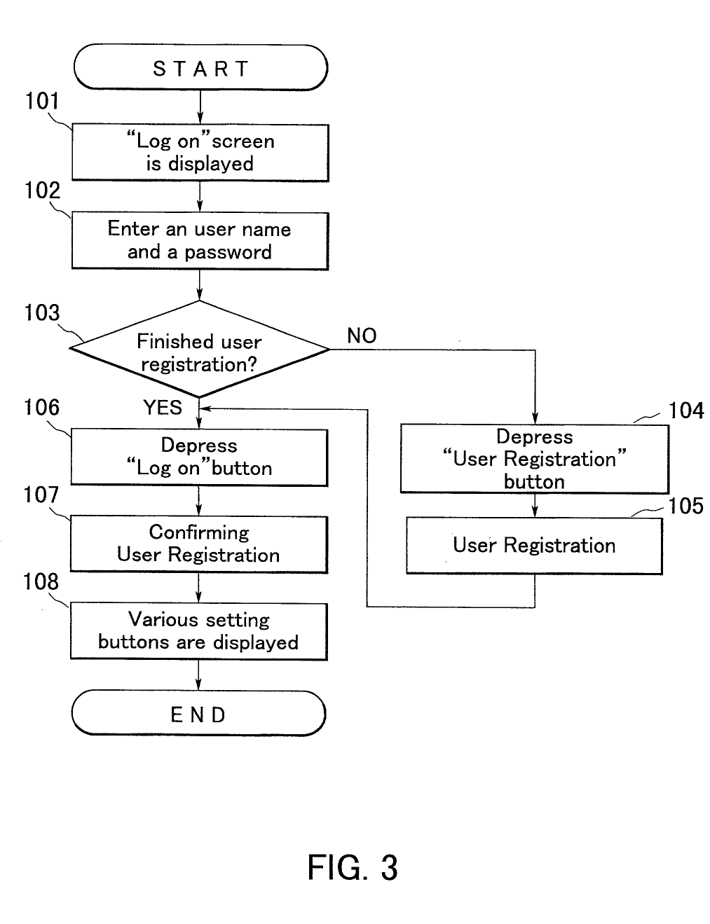

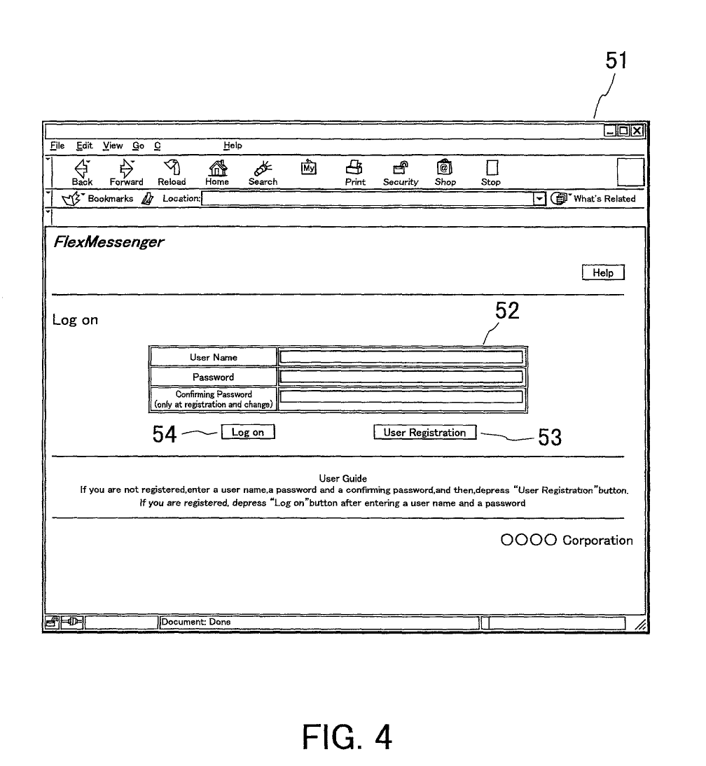

When a transfer system setting program of the E-mail transfer device 3 is started, a “Log on” screen 51 is displayed on the client device 2, as shown in FIGS. 3 and 4 (101). In the “Log on” screen 51, registration of a user of the E-mail transfer system and confirmation of the user can be confirmed.

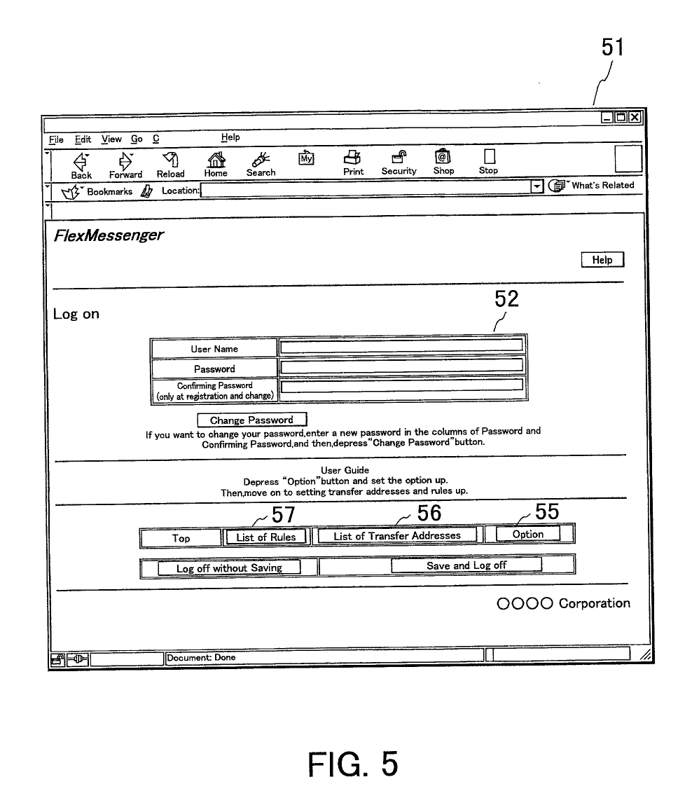

A user name and a password are input in a user description column 52 (102), and where registration of a user is not yet finished (103), if a “user registration” button 53 is depressed (104), the user is registered in the E-mail transfer device 3 (105), after which the E-mail transfer system can be used.

Where the user registration is finished (103), if the “Log on” button 54 is depressed (106), the user is confirmed in the E-mail transfer device 3 (107), and various setting buttons are displayed on the “Log on” screen 51 (108), as shown in FIG. 5, after which one can get access to various setting and display screens.

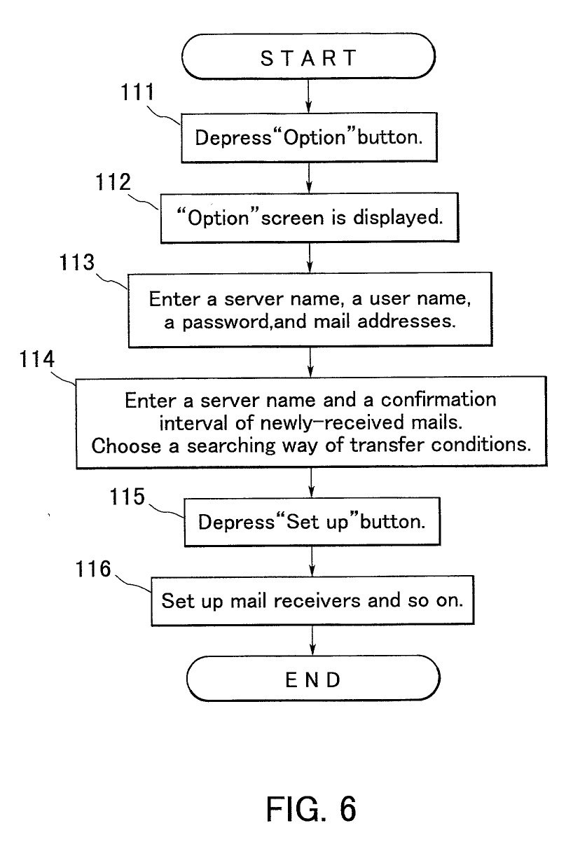

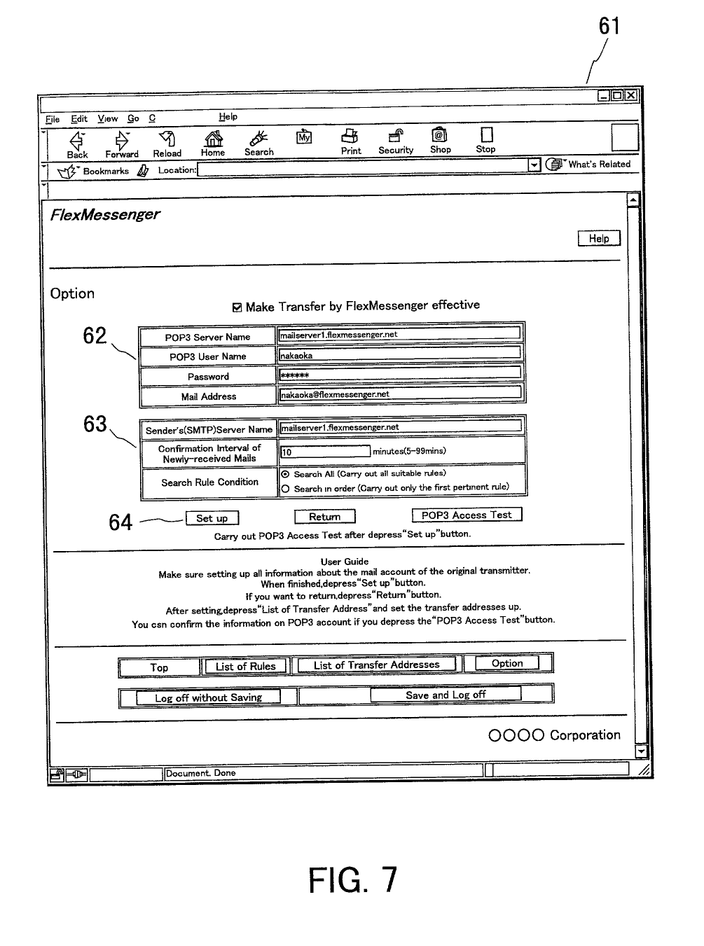

If in the “Log on” screen 51, an “Option” button 55 is depressed (111), the transfer condition setting section 13 of the E-mail transfer device 3 is started so that an “Option” screen 61 is displayed as shown in FIGS. 6 and 7 (112). In the “Option” screen 61, a receiver of E-mail, a confirmation interval of newly-received mails, and a transfer condition search method can be set.

A mail server name, a user name, a password, and a mail address are input in the receiver setting column 62 (113); a mail server name, and a newly-received mail confirmation interval are input and transfer condition search method is selected in the option setting column 63 (114). If a “Setting” button 64 is then depressed (115), the receiver of E-mail, the newly-received mail confirmation interval and the transfer condition search method are set (116).

In the present embodiment, in the receiver setting column 62, “mail server 1. flexmessenger. net” as a mail server name, “nakaoka” as a user name and a password are input; and in the option setting column 63, “mail server 1. flexmessenger. net” as a mail server name, and “10”minutes as a newly-received mail confirmation interval are input, and search of all the transfer conditions as a transfer condition search method is selected.

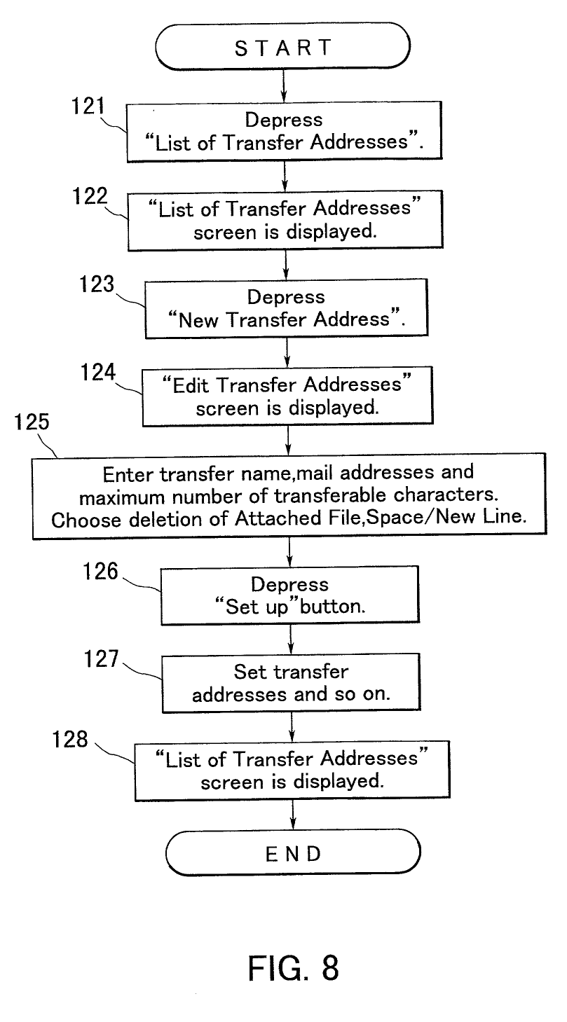

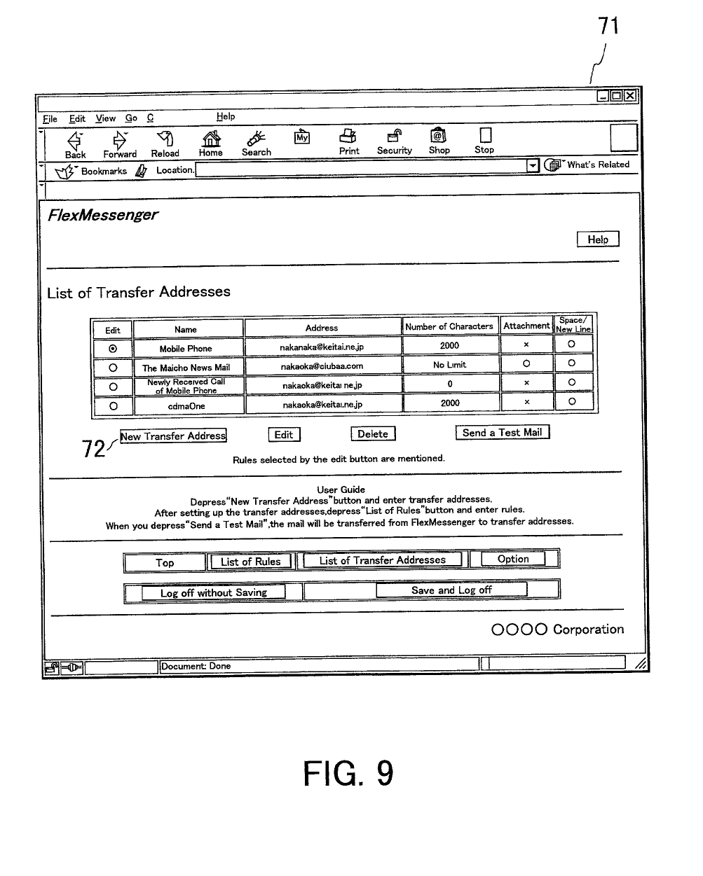

In the “Option” screen 61, if the “List of Transfer Addresses” button 56 is depressed (121), the transfer condition setting section 13 of the E-mail transfer device 3 is started, and a “List of Transfer Addresses” screen 71 is displayed (122) as shown in FIGS. 8 and 9. On the “List of Transfer Addresses” screen 71, a transfer address of the E-mail, the maximum number of transferable characters, a deletion of an attached file, and a deletion of Space/New Line and so on are displayed.

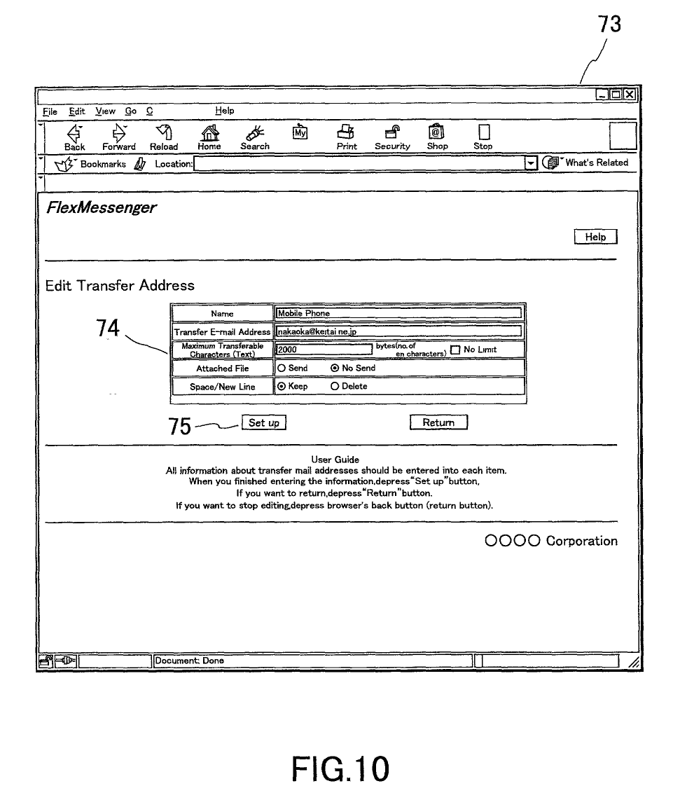

If in the “List of Transfer Addresses” screen 71, a “New Transfer Address” button 72 is depressed (123), the transfer condition setting section 13 is started, and a “Edit Transfer Address” screen 73 is displayed, as shown in FIG. 10 (124). On the “Edit Transfer Address” screen 73, a transfer address of E-mail, the maximum number of transferable characters, a deletion of an attached file, , and a delection of Space/New Line and so on can be selected.

In the transfer address setting column 74, a name of a transfer address, a mail address, and the maximum number of transfer characters are input, and a deletion of an attached file and a deletion of Space/New Line are selected (125); and if the “Set up” button 75 is depressed (126), a transfer address of E-mail, the maximum number of transfer characters, a deletion of an attached file and a deletion of Space/New Line and so on are set (127), and the “List of Transfer Addresses” screen 71 is again displayed (128).

According to the present embodiment, in the transfer address setting column 74, “mobile phone” as a name of transfer address, “nakaoka@keitai.ne.jp” as a mail address of transfer, and “2000”bytes as the maximum number of transferable characters are input, an attached file is deleted at the time of transfer, and the existence of Space/New Line is selected.

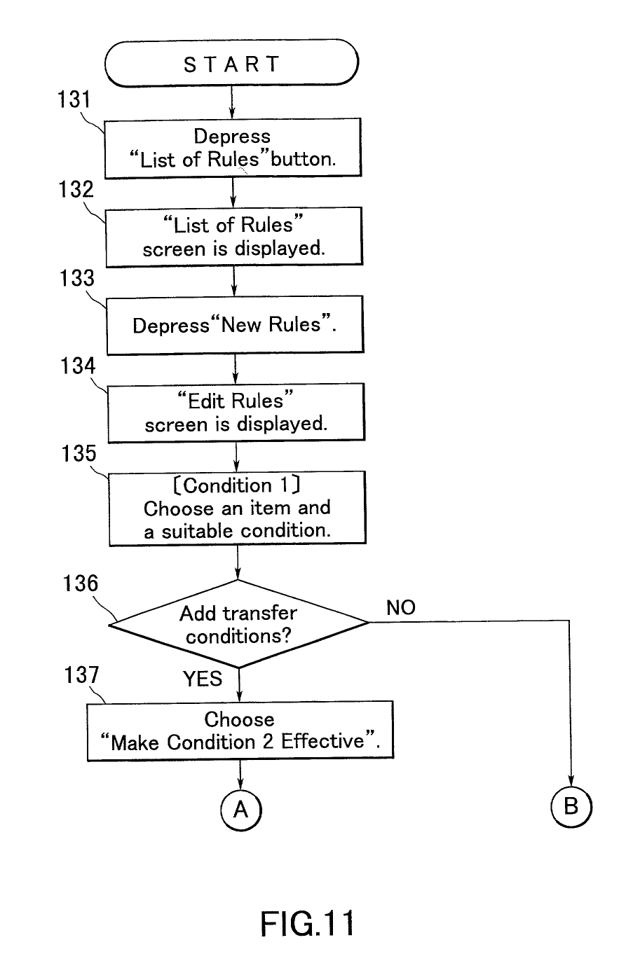

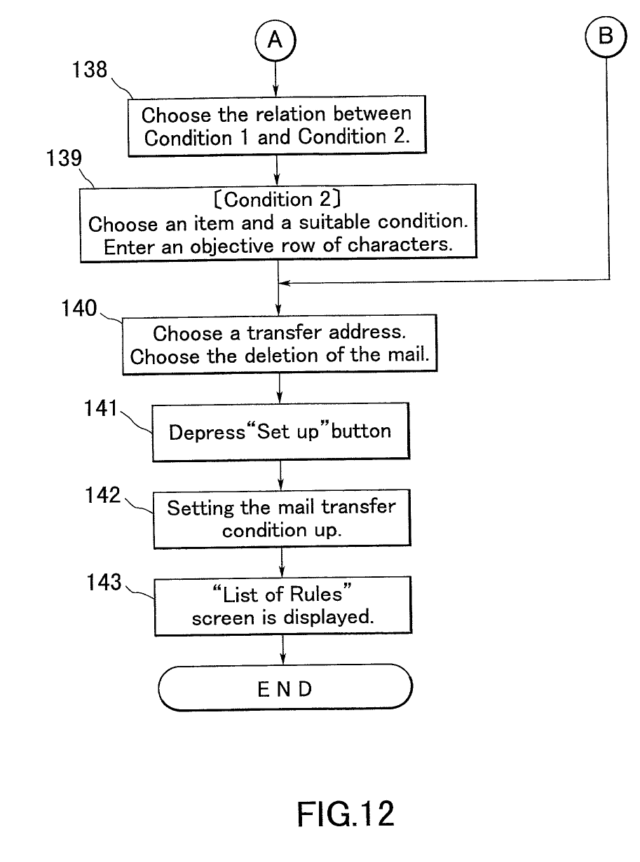

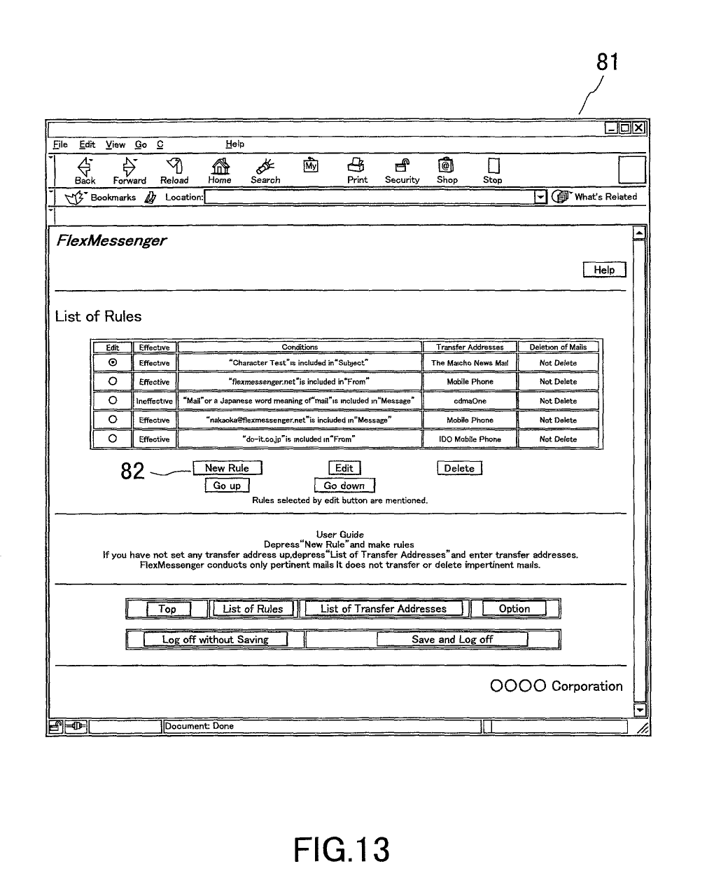

If, in the “List of transfer Addresses” screen 71, a “List of Rules” button 57 is depressed (131), the transfer condition setting section 13 of the E-mail transfer device 3 is started, and a “List of Rules” screen 81 is displayed as shown in FIGS. 11, 12 and 13 (132). In the “List of Rules” screen 81, the transfer conditions of E-mail, the transfer addresses and so on are displayed.

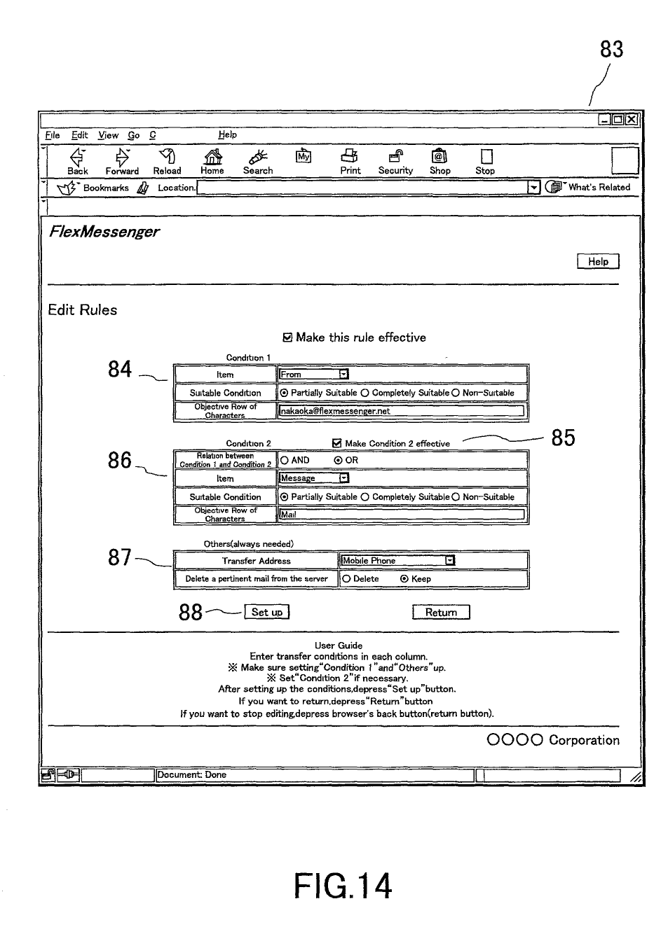

In the “List of Rules” screen 81, if a “New Rule” button 82 is depressed (133), the transfer condition setting section 13 is started, and an “Edit Rule” screen 83 is displayed as shown in FIG. 14 (134). In the “Edit Rule” screen 83, the transfer conditions of E-mail, transfer addresses and so on can be set.

In a condition 1 setting column 84, items of the transfer conditions, the coincidence conditions of a row of characters to be an object are selected and a row of characters to be an object are input (135). The items of the transfer conditions are “From, To, Subject, CC, Message (the body)” which are header information of E-mail.

Further, where the transfer conditions are added (136), “Condition 2 be effective” 85 is selected (137); in a condition 2 setting column 86, the relation between the condition 1 and the condition 2 is selected (138); and items of the transfer conditions and the coincidence condition of a row of characters to be an object are selected and a row of characters to be an object are input (139).

In a transfer address selection column (87), a transfer address when coincides with the transfer conditions is selected, and a deletion of the mail from a server is selected (140), and if a “setting” button 88 is depressed (141), the transfer conditions of E-mail, transfer addresses and so on are set (142), and the “List of Rules” screen 81 is again displayed (143).

According to the present embodiment, in the condition 1 setting column 84, “From (Transmitter)” as an item, a partial coincidence as the coincidence condition are selected, and “flexmessenger. net” is input as a row of characters to be an object; and in the condition 2 setting column 86, “Message (the body)” as an item, a partial coincidence as the coincidence condition are selected, and “mail” is input as a row of characters to be an object.

In the transfer address selection column 87, “Mobile Phone” as a transfer address and the existence of E-mail after transfer are selected.

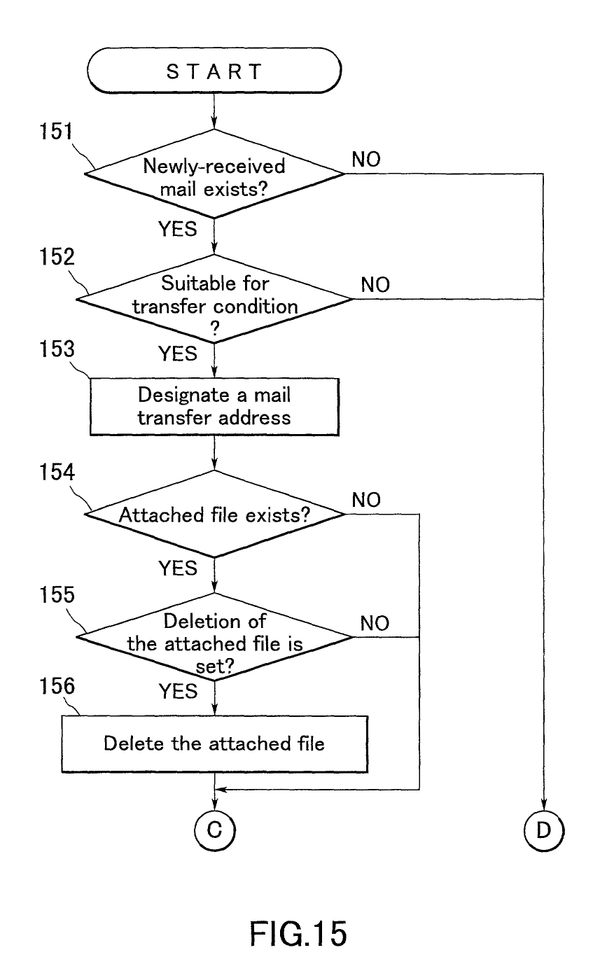

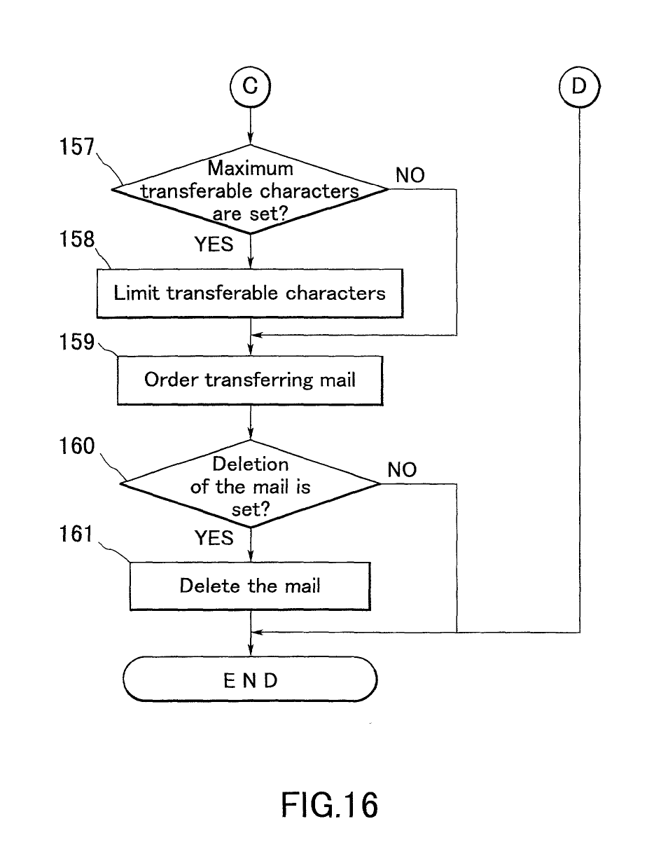

Next, the E-mail transfer method will be described with reference to the flow charts shown in FIGS. 15 and 16.

If a mail transfer program of the E-mail transfer device 3 is started, the newly-received mail confirmation section 13 is operated to confirm whether or not a newly-received mail addressed to the client device 2 is present in the mail memory section 11 of the mal server device 1 (151).

Where the newly-received mail is not present, there assumes a stand-by state till confirmation of a next newly-received mail. In the present embodiment, the confirmation of a newly-received mail is executed at intervals of 10 minutes.

Where a newly-received mail is present, the collation and determination section 16 is operated to collate the contents of the received E-mail with the transfer conditions stored in the transfer condition memory section 14 to determine whether or not the contents thereof coincides with the transfer conditions.

In the present embodiment, whether or not the row of characters to be an object “flexmessenger. net” is contained in the contents of the item “From”, or whether or not the row of characters to be an object “mail” is contained in the contents of the item “Message” is confirmed(152). If contained, determination is made to be coincided with the transfer conditions.

When coincided with the transfer conditions, the mail transfer command section 17 appoints a transfer address stored in the transfer condition memory section 14 for the mail transmission section 12 of the mail server device 1 (153).

In the present embodiment, an address “nakaoka@keitai.ne.jp” of the mobile phone 8 is appointed as a transfer address.

Further, the mail transfer command section 17 confirms whether or not an attached file is present (155) and confirms whether or not a deletion of an attached file is set (156). When set, a command for deleting the attached file is issued to the mail transmission section 12 of the mail server device 1 (156). Confirmation is also made whether or not the maximum number of transfer characters is set (17). When set, a command for limiting the maximum number of transfer characters is issued to the mail transmission section 12 of the mail server device 1.

In the present embodiment, there is a issued command for deleting an attached file and limiting the maximum number of transfer characters 2000 bytes.

Then, the mail transfer command section 17 issues to the mail transmission section 12 of the mail server device 1 a command for transferring E-mail received by the mobile phone 8 (159), and E-mail is preserved in the mail memory section 19 of the mail server device 9 without inconvenience.

Further, the mail transfer command section 17 also confirms whether or not the deletion of mail after transfer has been set (180). When set, the command section 17 issues a command for deleting the transfer mail from the mail memory section 11 of the mail server device 1.

In the present embodiment, since the setting for not deleting the mail after the transfer is made, the mail remains in the mail memory section 11 of the mail server device 1, and the mail can be read out of the client's device 2 even after the transfer.

As described above, according to the E-mail transfer method of the present invention, when the described matter of the body of E-mail coincides with the setting conditions, E-mail can be transferred to a transfer address suitably appointed. Therefore, E-mail received by the client device of a company can be transferred to the client device at a destination or to the client device at home according to the described contents of the body, and the received E-mail can be processed efficiently.

Further, since the attached file of E-mail can be deleted, and the number of transfer characters can be limited, E-mail received by the client's device of a company can be transferred to the mobile phone without inconvenience as it is, and the urgent information or the necessary information described in the body of E-mail received can be transmitted to business staff outside promptly.

In the transfer method, the transfer system and the transfer apparatus for E-mail according to the present invention, various functions such as shown below can be added.

One of additional functions is that by transmitting E-mail with a fixed form from a client device to the E-mail transfer apparatus 3, the mail transfer program is operated to start transferring E-mail, or the mail transfer program is suspended to stop transferring E-mail.

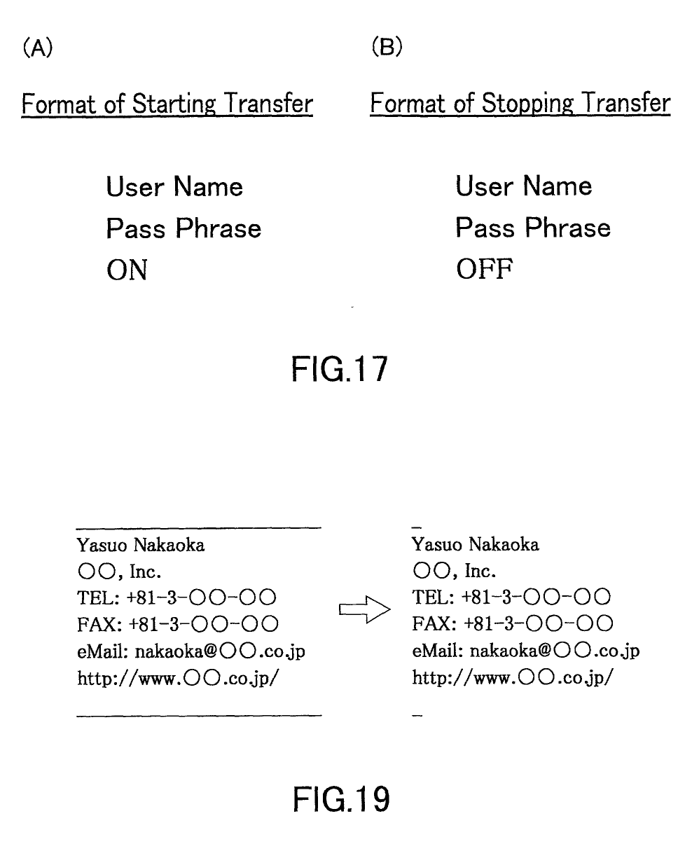

In case of starting to transfer an E-mail, as shown FIG. 17 (A), a user name, a pass phrase, and the control word “ON” are mentioned in the body of an E-mail to the E-mail transfer apparatus 3. In case of stopping to transfer an E-mail, as shown FIG. 17 (B), a user name, a pass phrase, and the control word “OFF” are mentioned in the body of an E-mail to the E-mail transfer apparatus 3.

According to the function of starting and stopping transferring an E-mail, it is extremely convenience that it is capable of indicating the start or stop transferring an E-mail by transmitting said E-mail with a mobile phone out of office and so on.

The function of replying a preset message automatically to the transmitter of an E-mail when the E-mail adressed to the client device 2 coincides with a transfer condition can be added.

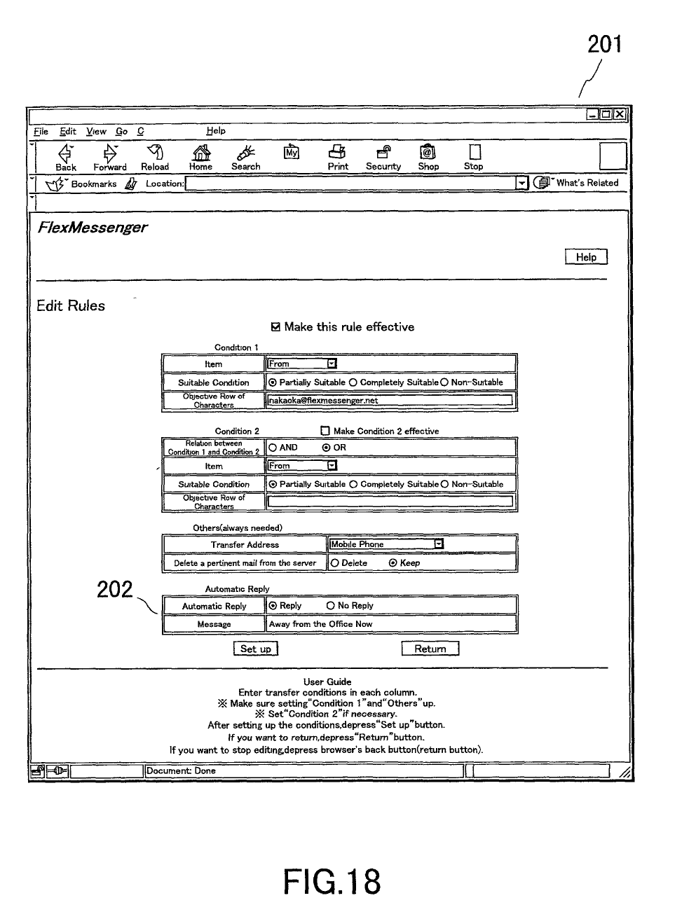

To carry out said function, an “Edit Rules” screen 201 as shown in FIG. 18 is prepared besides the above-mentioned “Edit Rules” screen 83, and in the automatic reply column, whether or not the automatic reply is needed is selected and a message is input. In the FIG. 18, the automatic reply is selected and “Away from the Office Now” is input as a message.

According to the automatic reply function, when any reply cannot be made by oneself because of being out of office for a long time and so on, a message such as “Away from the Office Now” can be replied automatically. Therefore, it is preferable that it enables to the transmitter to acknowledge the reason why the receiver is not able to respond.

Furthermore, it is possible to add another function that at the time when the contents of E-mail received are collated to a transfer condition, the E-mail transfer apparatus 3 dose not read out all the contents of the E-mail from the mail server device 1, but read out only the part of them.

For example, where the “body” of the E-mail is not selected as an item of transfer condition, only the header information of the E-mail is read out from the mail server device 1, but the body of the E-mail and the attached file are not read out. Also, where the “body” of the E-mail is selected as an item of transfer condition, the header information and the body of the E-mail are read out, but the attached file is not read out.

According to the reading-out-partially function, since the E-mail transfer apparatus 3 does not read out the unnecessary information, it enables to reduce the burden on the E-mail transfer device 3 as well as speed up the prosecution time.

In addition, when the mail transmitting section 12 of the mail server device 1 transfers an E-mail, in which N numbers of lines or characters such as “—,_,=,*” and so on, which are often used in the part of signing, are mentioned consecutively, the function of deleting characters from those of the second automatically can be added.

For example, as shown in FIG. 19, where a number of lines or characters “—” are mentioned consecutively in the part of the signing in an E-mail, the transfer command section 17 of the E-mail transfer apparatus 3 commands to delete “—” from those of the second automatically to the mail transmitting section 12 of the mail server device 1.

According to the delete function of consecutive characters, where an E-mail is transferred to a client device with a small screen, for instance, a mobile phone and so on, the description on the screen of a mobile phone and so on enables to be seen easily and clearly due to using only the limited space, and the telecommunication fee can be reduced due to the reduction of the number of characters transmitted.

Moreover, when the mail transmitting section 12 of the mail server apparatus 1 transfers an E-mail to a receiver having a limited capacity of receiving characters, such as a mobile phone, the function of dividing the transferring E-mail into some number of E-mail can be added.

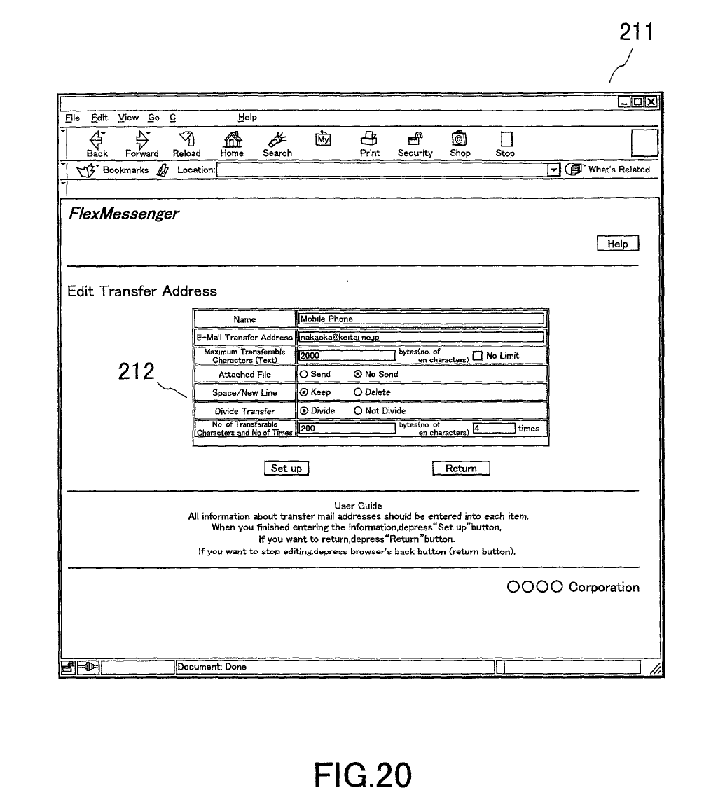

To carry out said function, the “Edit Transfer Address” screen 211 shown in FIG. 20 is prepared besides the above-mentioned “Transfer Address Edit” screen 73, and in the columns of setting a transfer address, whether or not the divided transfer is needed is selected and the number of transferable characters and times of the transfer are input.

In the FIG. 20, the divided transfer is selected, and “200 bytes” as the number of transferable characters and “4 times” as the number of times transferring are input, so that an E-mail consisting of 800 characters will be transferred 4 times which is divided into 4 E-mail consisting of 200 characters.

According to the divide function of transferring, all the contents of an E-mail having a of number of characters, though divided several times, can be received even by a mobile phone which has a limit of 250 receivable characters or so. Therefore, it does not happen that the content of the E-mail is not understandable.

What is claimed is:

1. A transfer method for E-mail characterized in that confirmation is made whether or not a row of characters to be an object as the transfer conditions preset is contained in the contents of the body of E-mail received, and if contained, determination is made that the transfer conditions are met, and said E-mail is transferred to a transfer address preset.

2. The transfer method for E-mail according to claim 1, wherein after E-mail has been transferred, said E-mail is remained in a mail server apparatus.

3. The transfer method for E-mail according to claim 1 or 2, wherein when E-mail is transferred, an attached file is deleted, Space/New Line is deleted, or the number of transferable characters is limited.

4. The transfer method for E-mail according to claim 1,2 or 3, wherein when the contents of E-mail received and a transfer condition are met, a fixed message is replyed to the transmitter of the E-mail.

5. The transfer method for E-mail according to claim 1,2,3 or 4, wherein when the contents of E-mail received is confirmed, only the part of the contents of E-mail is read out.

6. The transfer method for E-mail according to claim 1,2,3,4 or 5, wherein when E-mail is transferred, where a number of lines or characters and so on are mentioned consecutively, characters from those of the second are deleted automatically.

7. The transfer method for E-mail according to claim 1,2,3,4,5 or 6, wherein when E-mail is transferred, said E-mail is divided into a number of E-mail.

8. A transfer system for E-mail comprising; a transfer apparatus for E-mail comprising a transfer condition setting section capable of setting, as the transfer conditions, a row of characters to be an object supposed to be contained in the contents of the body of E-mail received and a transfer address, a transfer condition memory section for storing, as the transfer conditions, the row of characters to be an object supposed to be contained in the contents of the body of E-mail received and the transfer address, a newly-received mail confirmation section for confirming whether or not a newly-received mail is present within a mail memory section of a mail server's device, a collation and determination section for collating the body of E-mail received with the row of characters to be an object stored in the transfer condition memory section to determine whether or not the row of characters to be an object is contained in the contents of the body of the E-mail, and a mail transfer command section for issuing a command, to a mail transmission section of the mail server's device, so as to transfer the E-mail to the transfer address stored in the transfer condition memory section; and
A client device capable of getting access to the E-mil transfer device to enable inputting the row of characters to be an object and the transfer address as the transfer conditions.

9. A transfer apparatus for E-mail comprising; a transfer condition setting section capable of setting, as the transfer conditions, a row of characters to be an object supposed to be contained in the contents of the body of E-mail received and a transfer address, a transfer condition memory section for storing, as the transfer conditions, the row of characters to be an object supposed to be contained in the contents of the body of E-mail received and the transfer address, a newly-received mail confirmation section for confirming whether or not a newly-received mail is present within a mail memory section of a mail server's device, a collation and determination section for collating the body of E-mail received with the row of characters to be an object stored in the transfer condition memory section to determine whether or not the row of characters to be an object is contained in the contents of the body of the E-mail, and a mail transfer command section for issuing a command, to a mail transmission section of the mail server's device, so as to transfer the E-mail to the transfer address stored in the transfer condition memory section.

10. The transfer apparatus for E-mail according to claim 9, wherein said transfer condition setting section can set, as the transfer conditions, even the remaining or the deletion of E-mail in a mail server apparatus after the E-mail has been transferred, said transfer condition memory section can store, as the transfer conditions, even the remaining or the deletion of E-mail, and said mail transfer command section issues a command for remaining or deleting E-mail, after E-mail received has been transferred, in accordance with the remaining or the deletion of E-mail as the transfer conditions stored in said transfer condition memory section.

11. The transfer apparatus for E-mail according to claim 9 or 10, wherein said transfer condition setting section can set, as the transfer conditions, even the deletion of an attached file, the deletion of Space/New Line, and the maximum number of transferable characters, said transfer condition memory section can store, as the transfer conditions, even the deletion of an attached file, the deletion of Space/New Line, and the maximum number of transferable characters; and said mail transfer command section issues a command for deleting an attached file, deleting Space/New Line, and limiting the number of transferable characters, when E-mail received is transferred, in accordance with the deletion of an attached file, the deletion of Space/New Line, and the maximum number of transferable characters as the transfer conditions stored in said transfer condition memory section.

12. The transfer apparatus for E-mail according to claim 9,10 or 11, wherein by receiving a fixed format E-mail, starting or stopping of transferring E-mail is done.

13. The transfer apparatus for E-mail according to claim 9,10,11 or 12, wherein when the contents of E-mail received and a transfer condition are met, a fixed message is replied to the transmitter of the E-mail.

14. The transfer apparatus for an E-mail according to claim 9,10,11,12 or 13, wherein when the contents of E-mail received is collated with a transfer condition, only the part of the contents of the E-mail is read out from the mail server apparatus.

15. The transfer apparatus for E-mail according to claim 9,10,11,12,13 or 14, where a number of line characters and so on are mentioned consecutively, characterized in commanding the mail transmitting section of said mail server device to delete characters from those of the second automatically.

16. The transfer apparatus for E-mail according to claim 9,10,11,12,13,14 or 15, characterized in transferring E-mail received divided into a number of E-mail.
